(19) United States
(12) Patent Application Publication
(10) Pub. No.: US 2020/0010189 A1
(43) Pub. Date: Jan. 9, 2020

(54) TRANSVERSE FAN PROPULSION SYSTEM

(71) Applicant: General Electric Company, Schenectady, NY (US)

(72) Inventor: Peter Daniel Silkowski, Scotia, NY (US)

(73) Assignee: General Electric Company, Schenectady, NY (US)

(21) Appl. No.: 16/026,311

(22) Filed: Jul. 3, 2018

(51) Int. Cl. B64C 39/00; B64D 35/06; B64C 11/00; B64C 11/48; B64C 21/06

(52) U.S. Cl. CPC B64C 39/005; B64D 35/06; B64C 39/10; B64C 11/48; B64C 21/06; B64C 11/001

(57) ABSTRACT

A transverse fan propulsion system includes a first transverse fan configured to rotate in a first direction, and a second transverse fan configured to rotate in a second direction. The second direction is opposite to the first direction. The second transverse fan is located coaxially with and radially inward of the first transverse fan.

### BACKGROUND OF THE INVENTION

The apparatus described herein relates generally to a transverse fan propulsion system and, more specifically, to a transverse fan propulsion system having counter-rotating fans.

The transverse fan, sometimes known as a cross-flow fan is usually long in relation to the diameter, so the flow approximately remains two-dimensional away from the ends. The transverse uses an impeller with forward curved blades, placed in a housing consisting of a rear wall and vortex wall. Unlike axial fans, the main airflow moves transversely across the impeller, passing the blading twice.

### BRIEF DESCRIPTION OF THE INVENTION

In an aspect of the present invention, a transverse fan propulsion system includes a first transverse fan configured to rotate in a first direction, and a second transverse fan configured to rotate in a second direction. The second direction is opposite to the first direction. The second transverse fan is located coaxially with and radially inward of the first transverse fan.

In another aspect of the present invention, a transverse fan propulsion system has a first transverse fan, and a second transverse fan located downstream from the first transverse fan. The second transverse fan has an input that is operatively connected to an output of the first transverse fan. A movable barrier is located between the first transverse fan and the second transverse fan, an open position of the movable barrier permits airflow from the output of the first transverse fan to the input of the second transverse fan, and a closed position of the movable barrier prevents airflow from the output of the first transverse fan passing directly to the input of the second transverse fan.

In yet another aspect of the present invention, a transverse fan propulsion system includes a transverse fan, and a plurality of baffles axially spaced along a length of the transverse fan. The plurality of baffles are configured to force airflow to pass across the transverse fan multiple times.

### BRIEF DESCRIPTION OF THE DRAWINGS

FIG. 1 illustrates a schematic, cross-sectional view of a transverse fan propulsion system having concentric, counter rotating transverse fans, according to an aspect of the present disclosure.

FIG. 2 illustrates a schematic, cross-sectional view of a transverse fan propulsion system having multiple stage transverse fans, according to an aspect of the present disclosure.

FIG. 3 illustrates a schematic view of a transverse fan propulsion system 300, according to an aspect of the present disclosure.

FIG. 4 illustrates a transverse fan propulsion system having a variable bypass channel, according to an aspect of the present disclosure.

FIG. 5 illustrates a transverse fan propulsion system having a variable bypass channel, according to an aspect of the present disclosure.

FIGS. 6 and 7 illustrate the positioning of the transverse fan propulsion system on or in an aircraft, according to an aspect of the present disclosure.

FIG. 8 illustrates a schematic view of a transverse fan propulsion system having a baffled, multi-stage transverse fan, according to an aspect of the present disclosure.

### DETAILED DESCRIPTION OF THE INVENTION

One or more specific aspects of the present invention will be described below. In an effort to provide a concise description of these aspects, all features of an actual implementation may not be described in the specification. It should be appreciated that in the development of any such actual implementation, as in any engineering or design project, numerous implementation-specific decisions must be made to achieve the developers' specific goals, such as compliance with machine-related, system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present invention, the articles “a,” “an,” and “the” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one aspect” or “an aspect” of the present invention are not intended to be interpreted as excluding the existence of additional aspects that also incorporate the recited features.

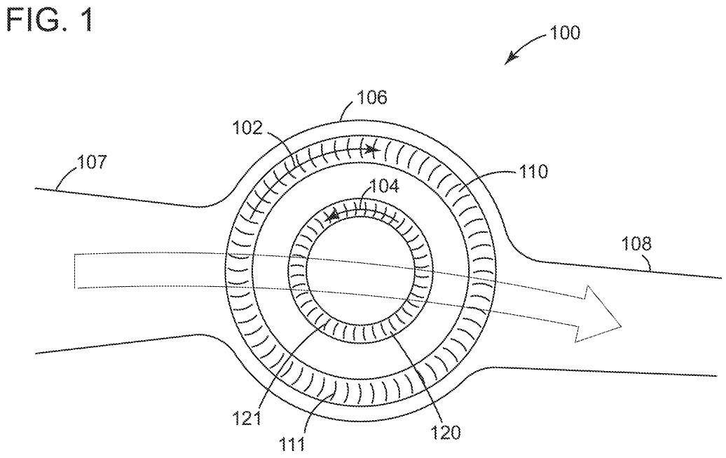

FIG. 1 illustrates a schematic, cross-sectional view of a transverse fan propulsion system 100 having concentric, counter rotating transverse fans. The transverse fans are long, cylindrical elements with each having a circumferential array of fan blades. A first transverse fan 110 rotates in a first direction 102 (e.g., clockwise in FIG. 1), and a second transverse fan 120 rotates in a second direction 104 (e.g., counter-clockwise in FIG. 1), where the second direction is opposite to the first direction. The rate of rotation of the first transverse fan 110 may be the same as or different from the rate of rotation of the second transverse fan 120. The second transverse fan 120 is located coaxially with and radially inward of or inside the first transverse fan 110. The transverse fan propulsion system is contained within a housing or enclosure 106, which has an input/inlet end 107 and an output/exhaust end 108. Each transverse fan has a circumferential array of fan blades 111 and 121. As the fan blades 111 rotate they draw air into the upstream side (e.g., 107) of the fan 110, the air is pushed axially downstream until it is acted upon by interior transverse fan 120. The air is acted upon by blades 121 on both the upstream and then downstream side of fan 120 and the air then progress further downstream to interact finally with the downstream side of fan 110. When the air finally exits the downstream side of fan 110 it is exhausted through outlet or exhaust 108, thereby providing thrust. In aircraft applications, the housing 106 may be a body of an aircraft or an airfoil (e.g., wing) or surface of the aircraft. An advantage of having two concentric, counter rotating transverse fans over a single transverse fan is the compactness of the compression system and increased pressure ratio.

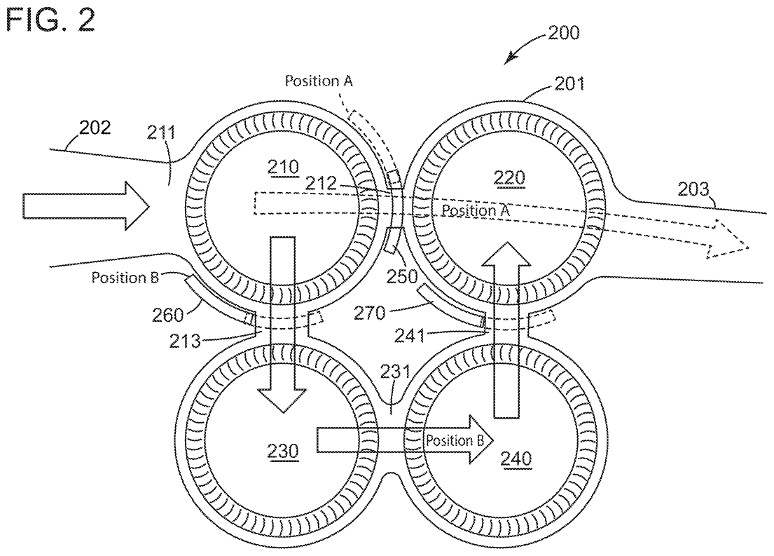

FIG. 2 illustrates a schematic, cross-sectional view of a transverse fan propulsion system 200 having multiple stage transverse fans. All the transverse fans in FIG. 2 are similar to transverse fan 110 of FIG. 1, in that they have a circumferential array of curved fan blades and the fan bodies are generally cylindrically shaped. The housing 201, which may be a body, wing or airfoil of an aircraft has an input/inlet 202 and output/exhaust 203. A first transverse fan 210 has an input 211, a first output 212 and a second output 213. A second transverse fan 220 is located downstream from the first transverse fan 210, and the second transverse fan 220 has an input 212 that is operatively connected to the output 212 of the first transverse fan 210. A movable barrier 250 is located between the first transverse fan 210 and the second transverse fan 220. An open position (illustrated by Position A in phantom) of the movable barrier 250 permits airflow between the output 212 of the first transverse fan 210 and the input 212 of the second transverse fan 220. This open position is accomplished when the moveable barrier 250 does not block airflow from passing through output/input 212. A closed position (illustrated by the solid lines) of the movable barrier 250 prevents or blocks airflow passing from the output 212 of the first transverse fan 210 to the input 212 of the second transverse fan 220. The closed position, as shown in FIG. 2, of the moveable barrier 250 blocks direct airflow passage between fans 210 and 220. For example, when moveable barrier 250 is in the open position airflow passes from input 202 to fan 210, through passageway 212 to fan 220, and then out to exhaust 203. This configuration yields the advantage of a lower pressure ratio as compared to the next configuration of the movable barriers where flow passes through four transverse fans.

A third transverse fan 230 is located downstream from the first transverse fan 210, and the third transverse fan 230 has an input 213 that is operatively connected to a second output 213 of the first transverse fan 210. A second movable barrier 260 is located between the first transverse fan 210 and the third transverse fan 230. An open position (as shown is Position B) of the second movable barrier 260 permits airflow to pass from the second output 213 of the first transverse fan 210 to the input 213 of the third transverse fan 230. A closed position (shown in phantom) of the second movable barrier 260 prevents airflow passing from the second output 213 of the first transverse fan 210 to the input 213 of the third transverse fan 230. A fourth transverse fan 240 is located downstream from the third transverse fan 230. The fourth transverse fan 240 has an input 231 that is operatively connected to an output 231 of the third transverse fan 230. The fourth transverse fan 240 has an output 241 that is operatively connected to a second input 241 of the second transverse fan 220. An open position (as shown in solid lines) of a third movable barrier 270 permits airflow to pass from the output 241 of the fourth transverse fan 240 to the second input 241 of the second transverse fan 220, and a closed position (shown in phantom) blocks airflow therebetween. When the moveable barriers 260 and 270 are in the open position, which allows airflow to pass from fan 210 to fan 230 to fan 240 to fan 220, the first moveable barrier 250 is in the closed position which blocks direct airflow between fans 210 and 220. In this configuration airflow passes in a multi-stage fashion from transverse fan 210, to transverse fan 230, to transverse fan 240 and then to transverse fan 220, which yields a four-stage transverse fan system. The four stages provide the benefit of a higher pressure ratio when required.

Alternatively, the transverse fan propulsion system 200 may be operated with moveable barrier 250 open and moveable barriers 260 and 270 closed. In this configuration airflow passes in a two-stage fashion through transverse fan 210 to transverse fan 220, without interacting with fans 230 or 240. The two-stage configuration provides the benefit of higher pressure, over a single-stage transverse stage system. In general, when barrier 250 is open, then barriers 260 and 270 are closed, and vice-versa. It is to be understood that any number of stages could be employed as desired in the specific application, and non-limiting examples are a 3-stage system, or a system having more than four stages. This enables variable pressure rise capability as may be required by the air vehicle for different flight conditions.

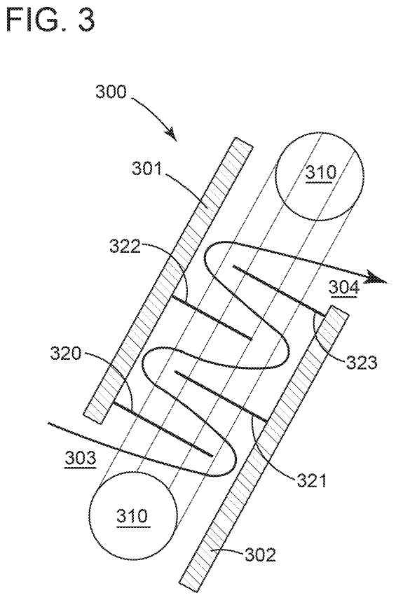

FIG. 3 illustrates a schematic view of a transverse fan propulsion system 300. A transverse fan 310 includes a plurality of baffles 320, 321, 322, 323 axially spaced along a length of the transverse fan 310. The baffles force airflow to pass across the transverse fan multiple times, and effectively create a multi-stage transverse fan out of one transverse fan. An upstream endwall 301 is located upstream of the transverse fan 310, and a downstream endwall 302 is located downstream of the transverse fan 310. A first subset of the baffles 320, 322 are connected to the upstream endwall 301 to direct airflow towards the downstream endwall 302. A second subset of the baffles 321, 323 are connected to the downstream endwall 302 to direct airflow towards the upstream endwall 301. Individual baffles of the first subset of baffles are alternately spaced along the length of the transverse fan 310 with individual baffles of the second subset of baffles. The baffles 320-323 act as walls or blocking members to prevent further lateral flow of the air. Air flow enters at inlet 303 and is driven towards endwall 302 by baffle 320, but is turned back across the fan 310 again towards endwall 301 by baffle 321. At the end of baffle 321 the air is turned back across the fan again by baffle 322 and is directed towards endwall 302. This process continues until the air finally exits out of outlet 304. It is to be understood that any number of baffles could be employed as desired in the specific application and as allowed by the length of the transverse fan 310. The endwalls 301, 302 may form a portion of the body of an aircraft or the wings or airfoils of an aircraft.

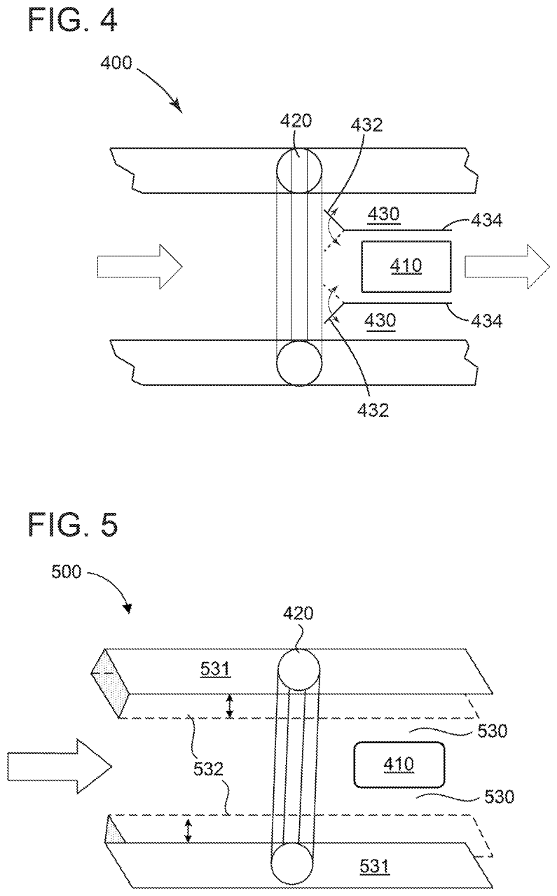

FIG. 4 illustrates a transverse fan propulsion system 400 having a variable bypass channel. A gas turbine core 410 is located downstream from, and may or may not be operatively connected to, a transverse fan 420. The core 410 may comprise a high-pressure compressor, a combustor and a high-pressure turbine. The transverse fan 420 may be powered by an alternative source, such as a motor, engine or other device as desired in the specific application. The gas turbine core 410 is located in a central region of an exhaust corridor of the transverse fan 420. A variable bypass channel 430 is used to modify exhaust amounts by diverting exhaust away from the gas turbine core 410, or by directing more exhaust from the transverse fan 420 to an input of the gas turbine core 410. The variable bypass channel 430 has moveable doors 432 connected to a fixed barrier 434 that selectively admit a greater amount of the exhaust when in a first position, and a lesser amount of exhaust when in a second position. For example, when doors 432 are in a closed position more air is directed into bypass channel 430 (which is a passage formed by barrier 434). Conversely, when doors 432 are in an open position less air is directed into bypass channel 430 and more air is directed into gas turbine core 410. The advantages of these configurations are variable bypass ratio as may be required by the air vehicle for different flight conditions.

FIG. 5 illustrates a transverse fan propulsion system 500 having a variable bypass channel. A gas turbine core 410 may be located downstream from the transverse fan 420. The gas turbine core 410 may be located in a central region of an exhaust corridor of the transverse fan. A variable bypass channel 530 is used to either increase or decrease the amount of bypass air or fan bypass flow. The variable bypass channel 530 has moveable endwalls 532 that admit a greater amount of the exhaust when in a first position, or a lesser amount of exhaust when in a second position. For example, when the moveable endwalls 532 are retracted to contact fixed endwalls 531, then the maximum amount of fan bypass flow is processed by the system. Conversely, when the moveable endwalls move towards each other and away from endwalls 531, then the amount of fan bypass flow is reduced. The advantages of these configurations are variable bypass ratio as may be required for different flight conditions. Additionally, both configurations shown in FIGS. 4 and 5 allow very high bypass ratios (e.g., greater than 15) without large fan diameters, and avoids limitations of tip mach number and nacelle drag (particularly when integrated into air vehicle structures or elements).

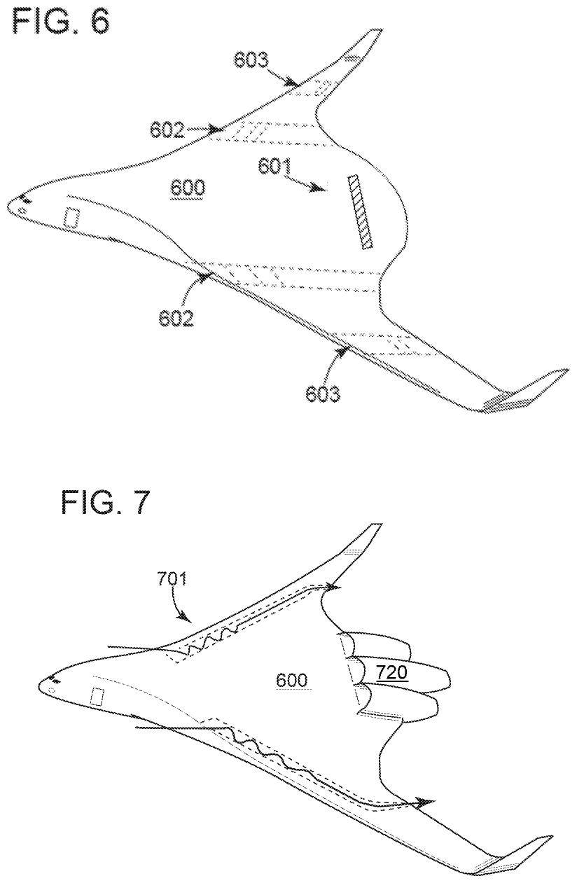

FIGS. 6 and 7 illustrate the positioning of the transverse fan propulsion system on or in an aircraft 600. In FIGS. 6 and 7 any of the transverse fan propulsion systems herein disclosed may be located in the body of the aircraft 600, or in a wing or airfoil of the aircraft. For example, location 601 illustrates a transverse fan propulsion system located in the body of the aircraft with an inlet slit along the aircraft surface, and specifically configured for boundary layer air ingestion. In the blended wing body application shown in FIG. 6, the transverse fan boundary layer air ingestion should have an aeromechanical advantage compared to the traditional fan 720 application shown in FIG.7. Locations 602 and 603 illustrate a transverse fan propulsion system located in the wing or airfoil of the aircraft, and these locations may also be configured for boundary layer air ingestion. Furthermore, these installations could use moveable barriers plus wing surface louvers to switch airflow direction from axial through the wing in forward flight to vertical through the wing for vertical take-off and landing (VTOL). The transverse fan propulsion system may be configured to ingest boundary layer air and located so the exhaust fills the aircraft wake. In FIG. 7, locations 701 illustrates a transverse fan propulsion system located in the wing or airfoil of the aircraft, and this may use a multi-stage transverse fan (as shown in FIG. 3). Only one wing is shown housing the transverse fan propulsion system, but it is to be understood that both wings would have the transverse fan propulsion system.

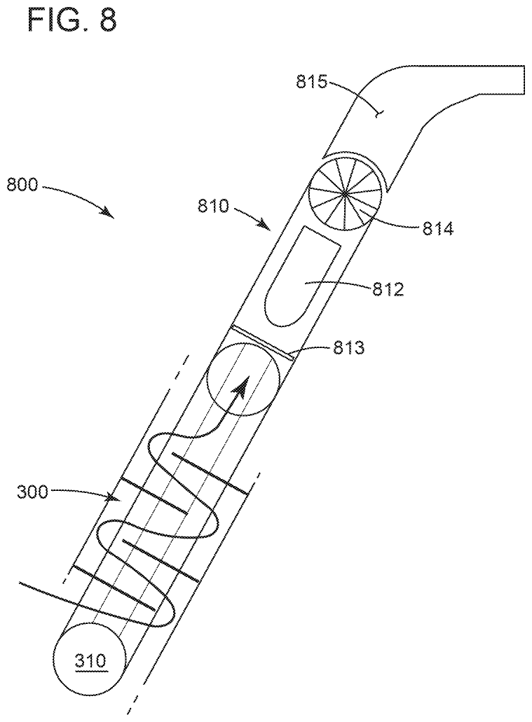

FIG. 8 illustrates a schematic view of a transverse fan propulsion system 800 having a baffled, multi-stage transverse fan connected as an input to a gas turbine engine. This is a novel integration of transverse and axial turbomachinery. The transverse fan system 300 is essentially the same as that shown in FIG. 3. A plurality of baffles direct airflow back and forth across transverse fan 310 to create a multi-stage transverse fan. The output of transverse fan 310 is directed into the optional axial compressor 813 then combustor 812 of a gas turbine engine 810. The combustor directs combustion gases into the axial turbine section 814 and subsequently out of the nozzle 816. An advantage of this type of configuration is novel packaging for applications such as that shown in FIG. 7 and a method for direct drive of the transverse fan.

It is to be understood that any of the transverse fan systems herein disclosed may be used with all of the transverse fan propulsion systems. For example, the fan system disclosed in FIG. 1 may be used in the aspects illustrated in FIGS. 2-8, the fan system of FIG. 2 may be used with the aspects illustrated in FIGS. 1 and 3-8, the fan system of FIG. 3 may be used with the aspects illustrated in FIGS. 1-2 and 4-8, the fan system of FIG. 4 may be used with the aspects illustrated in FIGS. 1-3 and 5-8, the fan system of FIG. 5 may be used with the aspects illustrated in FIGS. 1-4 and 6-8, and the fan system of FIG. 8 may be used with the aspects illustrated in FIGS. 1-7. All of the herein described and illustrated transverse fan propulsion systems may be located in the regions of an aircraft as illustrated by FIGS. 6 and 7.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A transverse fan propulsion system comprising:
a first transverse fan configured to rotate in a first direction;
a second transverse fan configured to rotate in a second direction, the second direction is opposite to the first direction; and
wherein the second transverse fan is located coaxially with and radially inward of the first transverse fan.

2. The transverse fan propulsion system of claim 1, wherein the first transverse fan and the second transverse fan are located in an aircraft.

3. The transverse fan propulsion system of claim 1, wherein the first transverse fan and the second transverse fan are located in an airfoil or a wing of an aircraft.

4. The transverse fan propulsion system of claim 1, further comprising:
a gas turbine core located downstream from the first transverse fan and the second transverse fan, the gas turbine core located in a central region of an exhaust corridor of the first transverse fan and the second transverse fan;
a variable bypass channel modifying exhaust amounts from the first transverse fan and the second transverse fan to an input of the gas turbine core, the variable bypass channel having moveable doors that admit a greater amount of the exhaust when in a first position, and a lesser amount of exhaust when in a second position.

5. The transverse fan propulsion system of claim 1, further comprising:
a gas turbine core located downstream from the first transverse fan and the second transverse fan, the gas turbine core located in a central region of an exhaust corridor of the first transverse fan and the second transverse fan;
a variable bypass channel modifying exhaust amounts from the first transverse fan and the second transverse fan, the variable bypass channel having moveable endwalls that admit a greater amount of fan bypass flow when in a first position, and a lesser amount of the fan bypass flow when in a second position.

6. The transverse fan propulsion system of claim 1, wherein an output of the first transverse fan and the second transverse fan are operatively connected to an input of a gas turbine core.

7. A transverse fan propulsion system comprising:
a first transverse fan;
a second transverse fan located downstream from the first transverse fan, the second transverse fan has an input that is operatively connected to an output of the first transverse fan; and
a movable barrier located between the first transverse fan and the second transverse fan, an open position of the movable barrier permits airflow from the output of the first transverse fan to the input of the second transverse fan, and a closed position of the movable barrier prevents airflow from the output of the first transverse fan passing directly to the input of the second transverse fan.

8. The transverse fan propulsion system of claim 7, further comprising:
a third transverse fan located downstream from the first transverse fan, the third transverse fan has an input that is operatively connected to a second output of the first transverse fan; and
a second movable barrier is located between the first transverse fan and the third transverse fan, an open position of the second movable barrier permits airflow to pass from the second output of the first transverse fan to the input of the third transverse fan, and a closed position of the second movable barrier prevents airflow passing from the second output of the first transverse fan to the input of the third transverse fan.

9. The transverse fan propulsion system of claim 8, further comprising:
a fourth transverse fan located downstream from the third transverse fan, the fourth transverse fan has an input that is operatively connected to an output of the third transverse fan, and the fourth transverse fan has an output that is operatively connected to a second input of the second transverse fan.

10. The transverse fan propulsion system of claim 7, wherein the transverse fan propulsion system is located in an aircraft, and the transverse fan propulsion system ingests boundary layer air and the transverse fan propulsion system is located so transverse fan propulsion system exhaust fills aircraft wake.

11. The transverse fan propulsion system of claim 7, wherein the transverse fan propulsion system is located in an airfoil or a wing of an aircraft.

12. The transverse fan propulsion system of claim 7, further comprising:
a gas turbine core located downstream from the first transverse fan and the second transverse fan, the gas turbine core located in a central region of an exhaust corridor of the first transverse fan and the second transverse fan;
a variable bypass channel modifying fan bypass flow from the first transverse fan and the second transverse fan, the variable bypass channel having moveable doors that admit a greater amount of the fan bypass flow when in a first position, and a lesser amount of the fan bypass flow when in a second position.

13. The transverse fan propulsion system of claim 7, further comprising:
a gas turbine core located downstream from the first transverse fan and the second transverse fan, the gas turbine core located in a central region of an exhaust corridor of the first transverse fan and the second transverse fan;
a variable bypass channel modifying exhaust amounts from the first transverse fan and the second transverse fan to an input of the gas turbine core, the variable bypass channel having moveable endwalls that admit a greater amount of the exhaust when in a first position, and a lesser amount of exhaust when in a second position.

14. The transverse fan propulsion system of claim 7, wherein an output of the first transverse fan and the second transverse fan are selectively operatively connected to an input of a gas turbine core.

15. A transverse fan propulsion system comprising:
a transverse fan;
a plurality of baffles axially spaced along a length of the transverse fan; and
wherein the plurality of baffles are configured to force airflow to pass across the transverse fan multiple times.

16. The transverse fan propulsion system of claim 15, further comprising:
an upstream endwall located upstream of the transverse fan and a downstream endwall located downstream of the transverse fan;
a first subset of the baffles are connected to the upstream endwall to direct airflow towards the downstream endwall; and
a second subset of the baffles are connected to the downstream endwall to direct airflow towards the upstream endwall.

17. The transverse fan propulsion system of claim 16, wherein individual baffles of the first subset of baffles and alternately spaced along a length of the transverse fan with individual baffles of the second subset of baffles.

18. The transverse fan propulsion system of claim 17, wherein the transverse fan propulsion system is located in an aircraft.

19. The transverse fan propulsion system of claim 17, wherein the transverse fan propulsion system is located in an airfoil or a wing of an aircraft.

20. The transverse fan propulsion system of claim 15, further comprising:
a gas turbine core with axial flow componentry integrated along an axis of the transverse fan propulsion system, and operatively connected to the transverse fan.
